(19) United States
(12) Patent Application Publication
(10) Pub. No.: US 2019/0392083 A1
(43) Pub. Date: Dec. 26, 2019

(54) WEB CONTENT CAPTURE AND VALIDATION CRYPTOGRAPHY

(71) Applicants: Jonathan Chan, Schenectady, NY (US); Arlen Olsen, Latham, NY (US)

(72) Inventors: Jonathan Chan, Schenectady, NY (US); Arlen Olsen, Latham, NY (US)

(21) Appl. No.: 16/017,604

(22) Filed: Jun. 25, 2018

(51) Int. Cl. G06F 17/30; G06F 21/60; H04L 9/08; H04L 9/30; H04L 9/14; H04L 9/32

(52) U.S. Cl. CPC G06F 17/30873; G06F 21/602; H04L 9/0825; G06F 17/30371; H04L 9/14; H04L 9/3247; H04L 9/30

(57) ABSTRACT

A method and system for web content capture and validation. The method includes receiving navigation instructions from a user to capture web content, automatically executing the navigation instructions along with content specific plug-in algorithms to arrange content for capture through a secure server, packaging the captured content along with the instructions, making the package available for download and encrypting the package with a digital signature such that a user may independently verify the integrity of the package. Additionally, the method includes a cloud component such that a user may optionally store captured content in the cloud and download the content at any time.

### FIELD OF TECHNOLOGY

The following relates to website capture, and more specifically to methods of capturing web content which allows for independent validation using validation cryptography.

### BACKGROUND

As the internet continues to grow, an increasingly large portion of everyday life is now conducted online. People conduct business and share personal information using various websites. Products are bought and sold, information is disseminated, and statements and videos are posted. As such, when disputes arise, key evidentiary information often exists online. This may be in the form of a webpage, a picture, or an advertisement. Therefore, it becomes necessary for a user to capture the web content for use as evidence.

Capturing web content presents issues as the legitimacy of the website capture is often questioned. Additionally, forums where web content is used as evidence, such as in a state or federal court, require that the web content be authenticated to be admitted. This often requires the capture of hidden content not readily ascertainable to average users to ensure that the chain of custody is maintained. Additionally, the internet, by its nature, is ever changing and webpages can be altered at a moment's notice.

Thus, a need exists for a legally defensible, repeatable, automated and transparent method for website capture and validation which allows users to easily retrieve captured data while maintaining the captured data's integrity.

### SUMMARY

A first general aspect relates to a website capture component which may be available in the cloud wherein a user may request, but not directly manipulate, a modern web browser to capture screenshots, metadata, and source files of any web site through a user specifying the content which they want to capture using a web portal, viewing the results of the captured content on the web portal, and adjusting the results using various tools such as fine-tuning the area to be captured. A user may then save the captured content in the cloud or download the content to the user's local machine. The web content capture component may avoid concerns such as caches and hidden content which require optimizations through the use of custom plug-in based algorithms.

A second general aspect relates to a validation cryptography component which allows a user to store any captured content on a secure server, utilizing asymmetric key, or public key, cryptography to guarantee the integrity of the stored content. A user may optionally directly download packages of stored content, which is signed by a private key, and be provided with a public key for verification; wherein a user may independently validate the integrity of the package using the public key. Additionally, where users have saved the packages in the cloud, a user may re-download the package of stored content at any time on a number of machines or devices.

A third general aspect relates to additional accompanying services provided to users capturing web content including sworn affidavits providing sworn statements which may be used in litigation, scheduled captures of the same content such that changes to the content may be tracked, and additional consulting services providing advice and guidance to users.

A fourth general aspect relates to a web content capture and validation apparatus comprising:

a search engine for searching for a copyright or trademark violation.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 illustrates a block diagram of an embodiment of a website capture method, in accordance with embodiments of the present invention.

FIG. 2A illustrates a first user display, in accordance with embodiments of the present invention.

FIG. 2B illustrates a second user display, in accordance with embodiments of the present invention.

FIG. 2C illustrates a third user display, in accordance with embodiments of the present invention.

FIG. 3 illustrates a cloud computing environment, in accordance with embodiments of the present invention.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

As a preface to the detailed description, it should be noted that, as used in this specification and the appended claims, the singular forms “a”, “an” and “the” include plural referents, unless the context clearly dictates otherwise.

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, spark, R language, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, device (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing device, or other device to cause a series of operational steps to be performed on the computer, other programmable device or other device to produce a computer implemented process, such that the instructions which execute on the computer, other programmable device, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

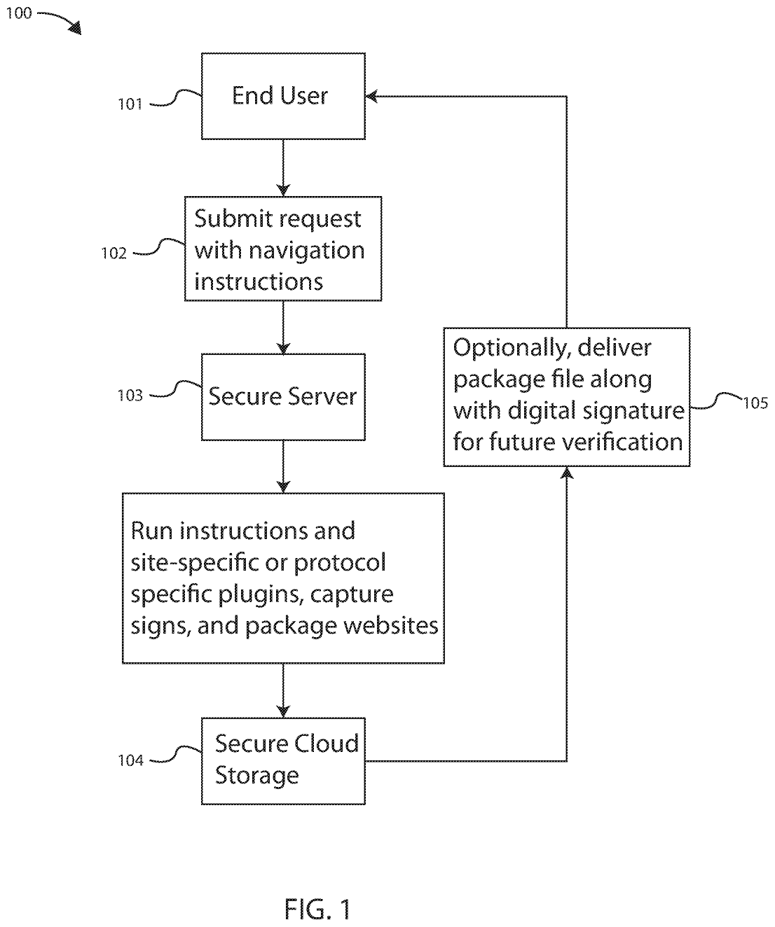

Referring to the drawings, FIG. 1 illustrates a system 100 for improving web data capture, storing that data via a secure server or cloud based storage, and providing the captured content digitally encrypted to allow a user to independently verify the integrity of the captured content, in accordance with embodiments of the present invention. System 100 enables a process for automatically capturing web content, via execution of machine learning code, based on user-supplied and plug-in-based algorithms in real time. Results of the captured web content are presented to a user, who may optionally fine-tune, but not directly manipulate, the area captured. Results may then be stored in a secure server or optionally stored in a secure cloud-based environment. Additionally, a user may choose to download the captured content to a local machine, wherein the captured content will be signed with an encrypted digital signature to allow for the user to independently validate the integrity of the captured content.

System 100 includes a user 101, navigation instructions 102, a secure storage server 103, a secure cloud-based storage 104, and a validation cryptography system 105. The user 101 may be an individual, a law firm, a company, or a third-party performing a service for individuals. Navigation instructions 102 may user 101 provided instructions or plug-in-based algorithms to navigate web pages to avoid concerns such as hidden content and caches. User 101 provided instructions may include a website URL address, cookies (which may be copied from the user 101's web browser), authentication information, and specific program scripts which navigate within a single page application. These navigation instructions 102 are defined and recorded as essential parts of the capture. The instructions allow for the capture to take place automatically in real time, without having a user manipulate a browser until they reach the desired content. Instead, the instructions are entered by the user and the system then automatically captures the desired content. Further, the recording of all instructions allow for a user to quickly and easily repeat a previous capture by loading the recorded instructions. The recorded instructions, stored along with the capture itself, also provide another level of authentication as they may be reviewed to determine the steps taken to capture the web content, and any modifications within the instructions to obtain a fraudulent capture would be clearly evident.

User authentication may be used as part of the capture process. For example, if someone must be logged into facebook in order to see particular content, an embodiment of the present invention may mimic (and store) the client's authentication cookies or other session data. With the mimicked client authentication data results may be obtained so that the authenticated user would have authentication even though a remote server is being used.

Additionally, an embodiment may optionally store other data aside from images, such as scripts, metadata, etc, for a variety of reasons including cases like where a site is actually pulling trademarked images/assets directly from a victim's own website vs copying it and hosting it themselves. Basically the image is primarily what is used for the evidence, but additional data can also automatically analyze and bundle in other data that could also be useful to prove method or intent.

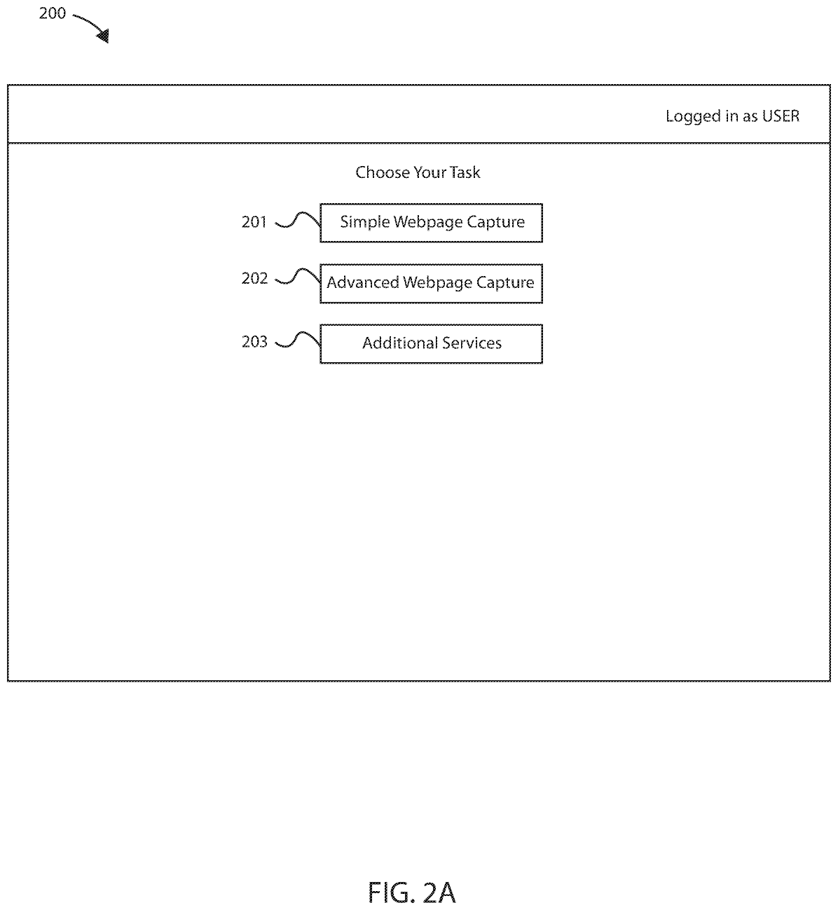

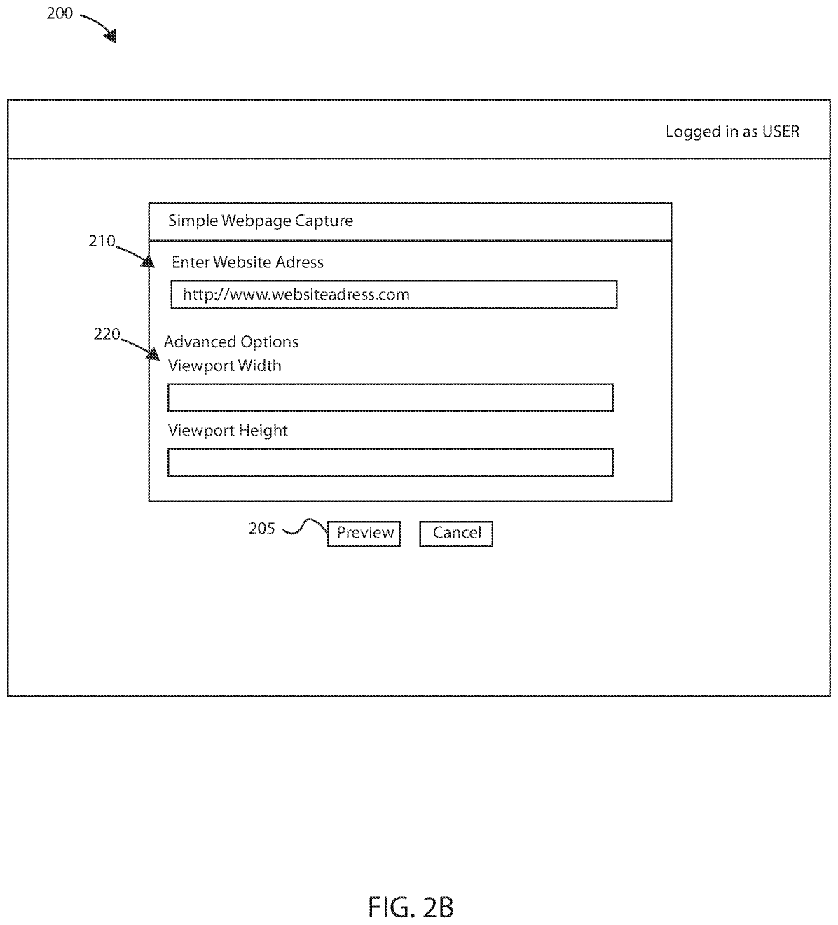

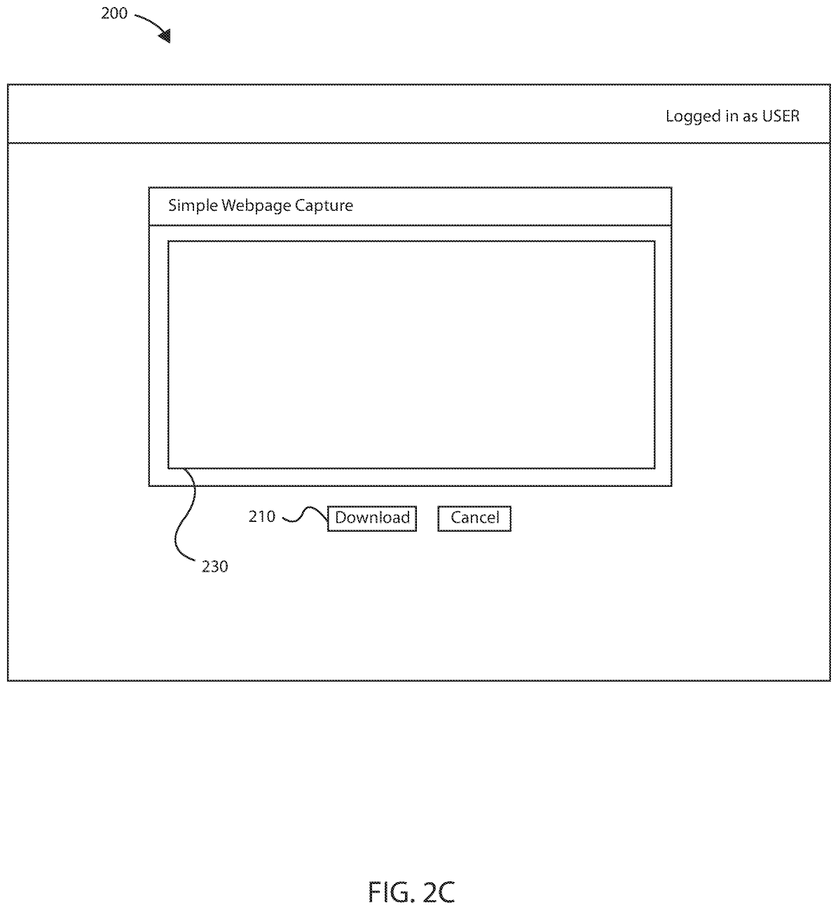

In one embodiment, system 100 may be accessed by a user via a web portal. In other embodiments, the system 100 may also be accessed from a program downloaded directly to a local machine. FIG. 2A illustrates an exemplary user display 200. Users are presented with a number of options, such as simple webpage capture 201, advanced webpage capture 202 and additional services 203. Other options may include scheduled captures, access stored captures, repeat previous captures, or request help.

Additional services 203 may be optional or they may come automatically as a part of the system. These services may be performed by the system or by third-parties and may include references to other outside systems. It should be noted that the services discussed herein are exemplary in nature and should not be considered an exhaustive list.

A first additional accompanying service may include providing a sworn affidavit with the captured content to enhance admissibility during litigation. This sworn affidavit may include a sworn statement that the content has not been tampered with and is a true and accurate representation of the content at the time it was captured. Additional information in the affidavit may include the date and time of capture, the method of protection of the content, i.e., cryptography and secure servers, and an explanation as to how the system preserves the chain of custody. The affidavit may be available upon request or as part of the download package when a user downloads the captured content or the affidavit may be requested at any time after the capture has taken place.

A second additional accompanying service may include scheduled captures of the same content to track changes or build a portfolio of evidence. Web content can change quickly and often. As such, it may be beneficial to a user to track the changes made to the same web page. Additionally, scheduled captures may be useful to show that potentially infringing web content was not changed or modified over an extended period of time. Captures may be scheduled at times set by the user, such as every set number of hours, days, weeks, or months. These scheduled captures may then be packaged together such that a user may download all of the captures in one package at any time.

A third additional accompanying service may include comparisons of previously captured content. As discussed previously, users may need to track web content over a large period of time and content packages may include a large number of captures. Scheduled captures, as described above, or several user initiated captures may be compared to track all differences between the captured content. A user may then quickly and easily identify changes made in the web content over time. Additionally, the comparison service may identify small modifications in the web content which may be missed when reviewed by a user.

A fourth additional accompanying service may include a consulting service. This consulting service may come from a legal professional, a lawyer, or other third party. The consulting service may include recommendations as to the best way to produce captures to serve as evidence in a particular litigation, how often to schedule captures, which web pages to capture and which portions of the web page to capture, or recommendations to other third-party services which may be of interest to users. This service may be included with system 100 or it may be available optionally for a user to select at an added cost.

System 100 may be marketed to users as an all-inclusive web content capture service wherein the user is able to not only capture web content, but also utilize a number of additional services to aid in capturing legally defensible web based evidence. This may be useful to users who do not wish to combine a number of systems to achieve the end result of a legally defensible web capture, or to users who may require assistance is achieving this goal. As such, system 100 provides a user with an option to use a single system, decreasing the effort in time a user would have to put forth in capturing web content.

Referring now to FIG. 2B, an exemplary user display 200 when a user chooses a simple webpage capture 201 is illustrated. The user display 200 prompts the user to enter instructions 210. These instructions 210 may include user provided navigation instructions 102 (with reference to FIG. 1) discussed above. Further, a user is prompted to enter advanced instructions 220. Advanced instructions 220 may include viewport dimensions, cookies, or specific program scripts which navigate within a single page application. Once a user has entered all instructions, the may preview the web capture by pressing preview 205.

FIG. 2C illustrates the user display 200 when a user previews a web capture, as discussed above. The user may preview the capture 230 as it will appear when downloaded. A user may then choose to modify the instructions, or download the capture, by pressing download 210. If the user wishes to modify the capture, the user is returned to the user display shown in FIG. 2B, wherein the user may modify the instructions to achieve the desired capture. It should be noted that modifications to the content of the capture may not be modified, only to the size and location of the capture.

Sources of captured content may come from all across the web. Users may choose to capture content because of suspected copyright or trademark infringement, to record possible defamatory comments, or to track changes to a user's own webpage.

A user may optionally store downloaded captures on system 100's secure server 103, or in the secure cloud storage 104. Additionally, captures may be packaged together to form asset packages of all of the captured content by a specific user to be downloaded by the user. Further, a user may provide previously downloaded captures to the system and package the previously downloaded captures with a new capture, such that any previously downloaded captures may be expanded on over time. Additionally, permitting a user to download the captures at any time and store them on the user's local machines allows for the captures to be used in systems beyond the present invention.

Maintaining the integrity of the captured content is crucial for this system. As such, the captured content may be protected through a validation cryptography component. In one embodiment, asymmetric key cryptography, otherwise known as public key cryptography, may be used to encrypt the captured content to ensure the integrity of the captured content. It should be noted that in other embodiments different types of encryption may be used, such as symmetric encryption or other digital signatures.

Asymmetric key cryptography utilizes two keys, a public key which may be disseminated to widely to a large number of people, and a private key which is never distributed and kept secret. The key is a piece of information which determines the functional output of a cryptographic algorithm. Data encrypted with a public key can only be decrypted by the corresponding private key, and vice-versa.

The key pair, the public and private keys, may be generated using cryptographic algorithms based on mathematical problems such as certain, discrete logarithm, integer factorization and elliptic curve relationships. The algorithm will generate a public key and a private key which are mathematically linked to each other. In one embodiment, the Rivest-Shamir-Adleman (RSA) algorithm may be used; however, other key generating cryptographic algorithms are contemplated.

Once a public key and private key have been generated, data can be encrypted with the secret private key by system 100, creating a digital signature. This secure data can be sent to anyone with the corresponding public key. The data, along with the digital signature, may then be verified using the public key. A user may determine if the digital signature was made by the owner of the private key through the use of the corresponding public key. If the data was in any way altered or compromised, verification will fail.

It is computationally impracticable for anyone who does not know the private key to determine it from the public key or from any of the digital signatures. Therefore, assuming the private key has been kept secret, the authenticity of the data may be validated by using the distributed public key to decrypt the digital signature, which was created using the corresponding private key.

Referring again to FIG. 1, in one embodiment, the validation cryptography 105 involves users downloading asset packages, which contain captured web content, from the secure server 103 or cloud-based storage 104. The asset packages are then signed by the generated private key, creating an encrypted digital signature. The user is then provided with the corresponding public key. Users may then independently validate the integrity of the downloaded asset packages by decrypting the digital signature using the provided public key. If the asset packages have been altered or changed in any way from what was stored on the secure server at the time of capture, validation will fail and the user will know that the integrity of the captured content has been compromised.

Asset packages also include navigation instructions 102. Recording the navigation instructions 102 ensures that malicious manipulation to obtain fraudulent captures is not possible without being evident in the recorded navigation instructions 102. For example, if the navigation instructions 102 were manipulated (through java script hacks or SQL injections, for example) these manipulations would be evident in the recorded instructions. If these modifications took place after the user has downloaded the asset package, any future validations using the public key, as described previously, would fail and alert the user that the modifications have been made. Asset packages may also include information such as the time and date of the web capture, the user who initiated the capture, the IP address of the machine that initiated the capture, and other web tracking information such as flash cookies, server logs, and web beacons.

This open method of validation cryptography allows for the captured content to remain confidential while also enabling the content to be authenticated. A user may download captured web content from the secure server at any time and ensure that the content is a true and authentic copy of what was captured. Further, the validation cryptography method allows for a user to positively identify the source of the captured content (the owner of the private key) along with ensuring that the content has not been tampered with, guaranteeing that the package is a fair and accurate representation of the content at the time it was captured. Furthermore, as the navigation instructions and additional information are provided within the downloaded package, chain of custody can be preserved and may be easily identified for any potential litigation.

Moreover, permitting users to download the content, and optionally re-download the content if the user chooses to store the content in the cloud, allows for greater flexibility for the user. This open method of cryptography allows for a user to retrieve captured content without the need for separate later retrieval from the system's servers. This allows for captures to be used and expanded on over time and packaged together with new captures, along with making the captures available for use in other systems. As such, users are not required to store and retrieve captured content from the secure servers at a later date, but are still able to ensure the integrity of the captured content.

The following implementation example describes a process for web capture and validation by a user. It should be noted that this process is outlined for exemplary purposes only:

A user may wish to capture web content for a variety of reasons. For example, a user may believe that web content is infringing upon intellectual property owned by the user. As such, the user wishes to capture the infringing material to save as reliable evidence before the web content is modified or removed. The user may implement system 100 by visiting a web portal or by a computer readable hardware storage device storing a computer readable program code, the computer readable program code comprising an algorithm that when executed by a processor of a server hardware device implements system 100. The user may provide navigation instructions to system 100 as to what they wish to be captured, such as the URL web address. The user may then request the capture from system 100. System 100 will then return a preview of what it to be captured. At this time the user may adjust the capture by changing the dimensions or the area to be captured to either expand the capture or to focus on a particular part of the web content. However, it is important to note that the user may not adjust the actual content of the capture (i.e., the user may not change what is being captured, only the area and dimension of the capture). Once the user has reviewed the preview of the web content, the user may finalize the capture. At this time, the capture is stored on system 100's secure server. The capture is encrypted using the method discussed above and signed with a digital signature. The user is then provided with the option to store the capture on system 100's secure server, store the capture on the cloud (discussed further below), or to download the capture directly to the user's machine. When the capture is downloaded, the user is provided with the public key (corresponding to the private key which is used to digitally sign the capture). As such, the user can, at any time, independently validate the integrity of the capture by decrypting the digital signature with the public key. If decryption fails, the user will know that the capture has been compromised.

Additionally, the user may realize that the web content which they have captured has been modified since the time of the original capture. The user may again implement system 100 to capture the modified web content. However, as the navigation instructions provided earlier by the user have been saved, the user may quickly repeat the same capture. This allows for the user to easily repeat the capture and compare the two captures for any modifications. Further, the user may then package the two captures into an asset package, such that both captures will be provided in the same encrypted file to the user.

Further, if the user believes the web content will continue to change, they may schedule automated captures. The user may set an interval of time, such as once every month, to capture the same web content. This allows for the content to be continually captured without the user having to initiate the capture each time. These captures can again be packaged together and downloaded by the user at any time from the server or the cloud.

A user may then present these captures as evidence in litigation against the infringer. The captures, along with an affidavit from the system, can be presented to a state or federal court. The validation cryptography, along with the recorded instructions and additional information, explained within the sworn statement in the affidavit, will greatly reduce the effort needed to authenticate and identify the chain of custody during litigation, potentially reducing legal fees for the user.

### Cloud Computing Environment

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating sFystems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

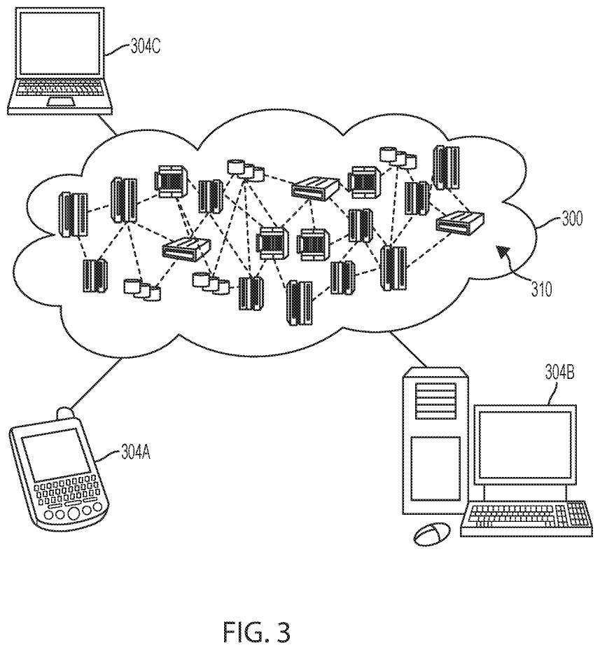

Referring now to FIG. 3, illustrative cloud computing environment 300 is depicted. As shown, cloud computing environment 300 includes one or more cloud computing nodes 310 with which local computing devices used by cloud consumers, such as, for example, personal digital assistant (PDA) or cellular telephone 304A, desktop computer 304B, and/or laptop computer 304C. Nodes 310 may communicate with one another. They may be grouped (not shown) physically or virtually, in one or more networks, such as Private, Community, Public, or Hybrid clouds as described hereinabove, or a combination thereof. This allows cloud computing environment 300 to offer infrastructure, platforms and/or software as services for which a cloud consumer does not need to maintain resources on a local computing device. It is understood that the types of computing devices 304A, 304B, and 304C shown in FIG. 3 are intended to be illustrative only and that computing nodes 310 and cloud computing environment 300 can communicate with any type of computerized device over any type of network and/or network addressable connection (e.g., using a web browser).

Cloud computing environment 300 allows for a user to optionally store and download captured web content at any time. With reference to FIG. 1, the user does not have to communicate with the secure server 103 to retrieve captured content, but rather may store the captured content in the cloud as illustrated by secure cloud storage 104. Further, as the captured content has been encrypted using the validation cryptography discussed above, a user can store captured content in the cloud, download the captured content at any time, while retaining the ability to independently verify the integrity of the captured content. Furthermore, a user is able to download stored content and utilize the system over a number of devices, such as home computers, laptops, and mobile devices.

An additional embodiment is to have a search engine search for counterfeit products on the web. In the case of a consumer product, the search engine would be geared toward searching certain websites or online market places that offer consumer products such as Amazon, ebay, Walmart. The search engine could target specific vertical consumer goods such as TrueFacet.com for jewelry or backcountry.com for outdoor enthusiasts. Also, it may be horizontal and cover may markets such as Panjo.com. A user would enter the marks or copyrighted images into a database and search for hits of intellectual property violations. If a violation is discovered the system will automatically or through a selection process capture and store images and or authentication information such as scripts, metadata, cookies, etc. The embodiment may also generate a notice letter based upon the search results of the violation.

While the above has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims. The claims provide the scope of the coverage of the invention and should not be limited to the specific examples provided herein.

What is claimed is:

1. A web content capture and validation method comprising:
receiving, from a user, a web content capture request and a set of navigation instructions to capture web content;
storing, by a processor of a hardware device, the set of navigation instructions;
automatically executing, by the processor in response to the set of navigation instructions, a capture of the web content;
storing, by the processor, the capture of the web content;
encrypting, by the processor, the capture resulting in an encrypted capture;
packaging, by the processor, the encrypted capture and the navigation instructions resulting in an encrypted capture package; and
offering for download, by the processor or a cloud network, the encrypted capture package.

2. The method of claim 1 wherein the captured web content is a web page.

3. The method of claim 1 further comprising displaying a preview of the captured web content to the user prior to storing the web content, allowing the user to adjust the captured content, wherein adjustments cannot be made to the content of the capture and are limited to dimensions or area to be captured, allowing the user to finalize the captured web content, and storing, by the processor, the finalized captured web content.

4. The method of claim 3 further comprising providing additional services to the user, wherein the additional services are at least one of a scheduled capture service, an affidavit service, a comparison service or an additional consulting service.

5. The method of claim 1 further comprising:
receiving, from a user, a request to schedule one or more captures of web content over a set interval of time;
scheduling, by the processor, a first capture of web content;
executing, by the processor, the first capture of the web content; and
automatically capturing, by the processor based on the set interval of time, a second capture of the web content at a later time determine by the set interval of time.

6. The method of claim 1 further comprising:
encrypting, by the processor, the encrypted capture package using asymmetric key cryptography;
generating, by the processor, a corresponding private key and public key for the encrypted capture package wherein the public key is required to decrypt content encrypted by the private key;
encrypting, by the processor, the encrypted capture package with the private key as a digital signature such that any variation in the encrypted capture package will result in a failure to decrypt the encrypted capture package; and
providing to the user, by the processor or cloud network, the encrypted capture package and the public key for independent user validation.

7. The method of claim 1 wherein the navigation instructions include at least one of a web address uniform resource locator (URL), HTTP cookies (provided by the user or copied from the user's web browser), or programming language to automatically navigate within a specified web page.

8. The method of claim 1 further comprising:
generating a content specific plug-in based algorithm in response to use specific concerns such as capturing hidden content or caches; and
automatically executing, by the processor, the plug-in based algorithm and the navigation instructions to capture the web content, including the hidden content or caches.

9. The method of claim 1 further comprising:
retrieving, by the processor, the stored navigation instructions;
repeating, by the processor, the web content capture.

10. The method of claim 1 further comprising:
receiving, from a user, a previously downloaded capture;
packaging, by the processor, the previously downloaded capture and the encrypted capture package resulting in an expanded capture package;
encrypting, by the processor, the expanded capture package; and
offering for download, by the processor or a cloud network, the encrypted expanded capture package.

11. The method of claim 1 wherein the encrypted capture package is downloaded to at least one of a home computer, laptop, or mobile device.

12. A computer program product, comprising a computer readable hardware storage device storing a computer readable program code, the computer readable program code comprising an algorithm that when executed by a processor of a server hardware device implements a web content capture and validation method, the method comprising:
receiving, from a user, a web content capture request and a set of navigation instructions to capture web content, wherein the navigation instructions include at least one of a web address uniform resource locator (URL), HTTP cookies (provided by the user or copied from the user's web browser), or programming language to automatically navigate within a specified web page;
storing, by the processor, the set of navigation instructions;
automatically executing, by the processor in response to the set of navigation instructions, a capture of the web content;
displaying a preview of the captured web content to the user;
adjusting, by the processor, the captured web content, wherein adjustments cannot be made to the content of the capture and are limited to dimensions or area to be captured;
finalizing, by the processor, the captured web content;
storing, by the processor, the finalized capture of the web content;
encrypting, by the processor, the capture resulting in an encrypted capture;
packaging, by the processor, the encrypted capture and the navigation instructions resulting in an encrypted capture package; and
offering for download, by the processor or a cloud network, the encrypted capture package to at least one of a home computer, laptop, or mobile device.

13. The computer program product of claim 12 wherein the captured web content is a web page.

14. The computer program product of claim 12, wherein the method further comprises providing additional services to the user, wherein the additional services are at least one of a scheduled capture service, an affidavit service, a comparison service or an additional consulting service.

15. The computer program product of claim 12, wherein the method further comprises:
receiving, from a user, a request to schedule one or more captures of web content over a set interval of time;
scheduling, by the processor, a first capture of web content;
executing, by the processor, the first capture of the web content; and
automatically capturing, by the processor based on the set interval of time, a second capture of the web content at a later time determine by the set interval of time.

16. The computer program product of claim 12, wherein the method further comprises:
encrypting, by the processor, the encrypted capture package using asymmetric key cryptography;
generating, by the processor, a corresponding private key and public key for the encrypted capture package wherein the public key is required to decrypt content encrypted by the private key;
encrypting, by the processor, the encrypted capture package with the private key as a digital signature such that any variation in the encrypted capture package will result in a failure to decrypt the encrypted capture package; and
providing to the user, by the processor or cloud network, the encrypted capture package and the public key for independent user validation.

17. The computer program product of claim 12, wherein the method further comprises:
generating a content specific plug-in based algorithm in response to use specific concerns such as capturing hidden content or caches; and
automatically executing, by the processor, the plug-in based algorithm and the navigation instructions to capture the web content, including the hidden content or caches.

18. The computer program product of claim 12, wherein the method further comprises:
receiving, from a user, a previously downloaded capture;
packaging, by the processor, the previously downloaded capture and the encrypted capture package resulting in an expanded capture package;
encrypting, by the processor, the expanded capture package;
offering for download, by the processor or a cloud network, the encrypted expanded capture package.

19. A cloud based web content capture and validation method comprising:
receiving, from a user, a web content capture request and a set of navigation instructions to capture web content, wherein the navigation instructions include at least one of a web address uniform resource locator (URL), HTTP cookies (provided by the user or copied from the user's web browser), computer readable program code to automatically navigate within a specified web page, and a content specific plug-in based algorithm;
storing, by a processor of a hardware device, the navigation instructions;
automatically executing, by the processor in response to the set of navigation instructions, a capture of the web content;
storing, by the processor, the capture of the web content;
encrypting, by the processor, the encrypted capture package using asymmetric key cryptography;
generating, by the processor, a corresponding private key and public key for the encrypted capture package wherein the public key is required to decrypt content encrypted by the private key;
encrypting, by the processor, the encrypted capture package with the private key as a digital signature such that any variation in the encrypted capture package will result in a failure to decrypt the encrypted capture package;
packaging, by the processor, the encrypted capture and the navigation instructions resulting in an encrypted capture package; and
offering for download, by the processor or a cloud network, the encrypted capture package, wherein the encrypted capture package and the public key are provided to the user for independent user validation.

20. A web content capture and validation method of claim 1, further comprising:
providing a search engine;
searching for a copyright or trademark violation through the search engine.
